(19) United States
(12) Patent Application Publication
(10) Pub. No.: US 2022/0202258 A1
(43) Pub. Date: Jun. 30, 2022

(54) CUTTING BOARD WITH A NARROW DEEP JUICE GROOVE CENTERED IN A SHALLOW WIDE JUICE GROOVE

(71) Applicants: Shawn Gregory Matthews, Accord, NY (US); Otto George Scherrieble, High Falls, NY (US)

(72) Inventors: Shawn Gregory Matthews, Accord, NY (US); Otto George Scherrieble, High Falls, NY (US)

(21) Appl. No.: 17/138,111

(22) Filed: Dec. 30, 2020

(51) Int. Cl. A47J 47/00

(52) U.S. Cl. CPC A47J 47/005

(57) ABSTRACT

A cutting board has an upper body, legs, and a drain pan. The top surface of the upper body has sloped dual, nested, concentric drain-grooves leading to a drain formed in the top surface. A first wide, shallow groove has a concentric deep, narrow a groove formed therein. A drain pan, housed below the drain in a space below the upper body. The drain pad has a rim that slides in and out of the front of the cutting board in tracks formed by slots in top surfaces of inner corners of the legs. The drain pan slides into the cutting board until the rim reaches stop points at the ends of the slots.

### TECHNICAL FIELD OF THE INVENTION

The present invention relates to food cutting boards adapted for collecting juices from food cut thereon, and more particularly to cutting boards with downwardly-sloped juice drainage grooves in the top surface of the cutting board leading to a drain hole provided for delivering the juices to an attached removable drain pan.

### BACKGROUND OF THE INVENTION

Richter U.S. Pat. No. 4,840,361 describes a rectangular cutting board with a cutting surface sloped from a long side to another long side starting from an edge bordering a peripheral juice channel to another peripheral juice channel on the opposite edge of the board.

Tice U.S. Pat. No. 4,907,789 shows a cutting board with an upper cutting surface with a peripheral groove sloped downwardly towards a slot with a collection bag.

Gibson U.S. Pat. No. 5,527,022 describes a cutting board with a cutting surface curved to allow fluid to flow into an indented juice channel in the cutting surface. The juice channel is indented in the cutting surface and spaced from and parallel to three sides of the board. The fourth side has a sloping guide plane. Two separate grooves extend from the two ends of juice channel. The grooves are shallower than the juice channel. The fluid emanating from the articles being cut will flow into the juice channel. After cutting, the fluid can be poured out of the juice channel through the two grooves by tilting the board.

Newton U.S. Pat. No. 6,644,639 describes a cutting board with an inclined planar upper surface. Juices are collected by a single narrow peripheral trough connected and a wide canal. The upper surface and peripheral trough slope at about 2 degrees from the front to the back. A corner well is formed toward the back that collects juices from the trough sections and the canal.

Benjamin U.S. Pat. No. 5,366,208 describes a cutting board mounts directly within a drip pan tray with several long notches, i.e. slits, around the periphery of the cutting board into which juices may flow into the drip pan tray.

Prosser U.S. Pat. No. 6,722,644 B1 describes a cutting board with large diameter central drain holes and a peripheral trough with small diameter drain holes with a drain pan below.

Funk U.S. Pat. No. 7,178,798 B1 shows an elliptical cutting board having a cutting surface surrounded by a single peripheral drain channel extending around the cutting surface of the cutting board with both ends draining into a reservoir lower than the channel.

Pearl U.S. Pat. No. 7,422,201 B2 and U.S. Pat. No. 8,286,956 B2 both describe catching scraps or juices on a cutting board with recessed channels in a cutting board with a peripheral groove(s) on the sides to guide unwanted juices from the cutting board into a pan installed in a drain hole. The groove(s) are cut into the surface of the cutting board at increasing depths to let juices to flow freely into the pan.

Torlai U.S. Pat. No. 9,687,113 B2 shows a cutting board. Liquid is directed via several tapered channels separated by through holes surrounding the cutting surface into a reservoir.

Davis US App 2005/0040580 A1 describes a cutting board composed of, high density polyethylene, wood or durable, non-porous, odor-resistant polypropylene dishwasher safe boards that are BPA (BisPhenol A.). Juices, from cut food products drain through apertures on the periphery of the cutting board.

Colletti U.S. Pat. No. 10,433,676 B2 shows a cutting board with a single peripheral channel in the cutting board surface inclined from a higher end down to a lower end where liquid waste flows into a reservoir. A drainage valve and a drainage port can fill a waste receptacle (not shown) below the drainage port.

Scott US App 2019/0320853 A1 describes a cutout below a hole in a single peripheral drainage groove. A concept is described of a container having an upper rim with a lip and a cutout channel for holding the container under the hole with the container portion (described but not shown) sliding into and out of the cutout channel.

Black US App 2012/0242026 A1 describes a non-porous cutting board with a top piece and two leg pieces, which elevate and tilt the cutting board. The tilt is such that two separate grooves on the top piece facilitate the easy removal of juices into a collection device (not shown) that fits under the elevated top piece and between the leg pieces. All of the pieces can be cleaned in a high temperature washing system. The combination of disengageable leg pieces, elevation, tilt, helps sanitation. The two separate grooves spaced far apart, run parallel for a distance and then angle towards each other and towards the front of the top piece without joining. The elevation and size of the cutting board are sufficient to permit the placement of a juice collection device under the top piece, between the legs.

### BRIEF SUMMARY OF THE INVENTION

In the past, there has been a problem with the use of drain grooves on a cutting board as they are often obstructed by debris such as particles of meat or vegetables or fruit produced during the cutting process. In that case, the debris clogging the grooves slows the flow of the fluids or juices into a receptacle. The resulting slowing of juice flow has been unacceptable, as such a slow rate of flow of the juices delays preparation of gravy and serving of a meal while the food is cooling excessively. Those problems are overcome by the present invention.

In accordance with this invention, a planar, upper body of a rectangular cutting board has a top surface, an underside, a front side, a back side, a left side, a right side, a drain-groove, and a drain hole. The upper body is supported by and secured to two lateral legs below the left and right sides of the cutting board. A drain pan for receiving juices from a drain hole through the upper body is removable from the cutting board. The drain pan has a surrounding drain pan rim. The drain pan rim is supported by and slides in and out of bilateral housing tracks formed by slots between the underside of the upper body and recesses in the inside upper corners of the legs. The lateral sides of the drain pan rim are supported by insertion of the drain pan rim into the bilateral tracks in the cutting board. The bilateral tracks formed by the housing slots are formed between the underside of the upper body and the top surfaces of bilateral recesses in the upper inside corners of the lateral legs. The drain pan rim is slidably insertable into the drain pan space and removable from the drain pan space. When the drain pan with its rim is inserted into the cutting board, it is supported by drain pan rim resting in the bilateral slotted tracks. The bilateral housing slots slotted tracks are located between the upper body and bilateral recesses in the inner corners on the tops of the two lateral legs. Thus, the drain pan, with its surrounding drain pan rim, slides in and out as the drain pan rim slides in and out of the drain pan housing slots between the upper body and matching recesses in the top surface on the inner sides of the legs.

The top surface of the cutting board has dual, coaxial, double ball milled drain-grooves, on the periphery. One coaxially ball milled groove is nested inside the other coaxially ball milled groove. In particular a superimposed, narrower deeper, ball milled drain-groove is centered coaxially within a wider, shallower, ball milled drain-groove.

In other words, around the periphery of the top surface of the upper body, the nested, coaxial, double ball milled, drain-grooves may be double ball milled by a Computer Numerical Control (CNC) vertical milling machine, or formed by an additive process such as 3 Dimensional (3D) printing (also known as additive manufacturing), injection molding, or lost wax casting of a metal cutting board are formed with the narrower, deeper drain-groove in the center of the wider shallower drain-groove.

As a result, the narrower, deeper drain-groove which is free of larger debris provides improved drainage of juices which flow unencumbered via the drain hole through the main body down into the hollow of the drain pan housed in the drain pan space below the cutting board.

Preferably, the drain-grooves slope downwardly, from a high point at the back of the cutting board inside the periphery of the top surface of the upper body to a low point at the drain hole centered in the top surface of the upper body above the hollow of the drain pan.

The drain-grooves start at the shallowest level in the middle of the back side of the board, extending both clockwise and counterclockwise along both the left side and the right side of the board to the opposite, i.e. front side, of the board where the grooves slope to the deepest level meeting at the edges of the drain hole.

The depths of both grooves slope from matched shallow depths on the back side of the board to greater matched depths in the middle of the front side of the board where they reach the juice drain hole. The deeper, narrow groove is provided for better, less obstructed, drainage for the juices produced from cutting of the food on the cutting board. This avoids the problem of food debris clogging the shallow groove alleviating the obstruction of the rapid flow of juices.

Thus, the juices pour more rapidly via the deeper groove into the hollow of a drain pan held by the drain pan rim which rests on the top surfaces of the recesses that support the drain pan rim on top of the inner sides of the lateral legs, whereby the removable drain pan is held between the lateral legs and below the upper body of the drain board.

The drain pan is removably supported by the drain pan rim that rests in tracks in the drain pan rim housing slots below upper body of the cutting board and on top of on the horizontal surfaces of the recesses in the top and inner sides of the lateral legs. Thus, the drain pan can slide in and out of the space provided by the drain pan rim housing slots.

It is an object of this invention to provide a cutting board with a drain pan which are easily cleaned; and with a drain pan below the cutting board surface in communication with drainage grooves, with the drain pan housed below the upper cutting board surface.

Another object of the invention is to provide a drain pan that slides in and out of the cutting board.

Still another object of the invention is to provide a cutting board which has drainage grooves designed to prevent debris from clogging the grooves thereby improving the flow of the fluids and juices into a drain pan.

A further object of the invention is to provide a cutting board it has recess is formed in the sides of the legs that support the upper body of the cutting board to facilitate handling of the cutting board before and after cutting food on the cutting board.

### BRIEF DESCRIPTION OF THE DRAWINGS

FIG. 1A is a perspective view of a sloped, dual-groove, peripheral, drain ring formed in a planar top surface of a cutting board and a drain pan.

FIG. 1B is a fragmentary sectional view showing the cross section of the peripheral drain ring taken along section line 1B-1B in FIG. 1A.

FIG. 2A is a plan view of the top surface of the upper body of the cutting board of FIG. 1A showing the peripheral drain ring with a narrow deep groove centered down inside the wide shallow groove.

FIG. 2B is an elevational view of the front of the upper body 11 the cutting board of FIGS. 1A and 2A.

FIG. 2C is an elevational, front views of both the left and right legs of the cutting board.

FIG. 2D is an elevational front view of the cutting board with the top surfaces of the left and right legs joined with the planar underside of the upper body forming drain pan rim housing slots.

FIG. 3A is a modified plan view of the top surface of the upper body of the cutting board of FIG. 1A

FIG. 3B is an elevational, front view of the cutting board of FIG. 3A with the left and right legs assembled with the underside of the planar, upper body of the cutting board.

FIG. 3C is an elevational, front view of the cutting board with the drain pan inserted into the open space below the upper body and between the lateral legs of the cutting board.

FIGS. 4A-4D are four elevational views showing phantom lines of the drain-grooves in the upper body viewed from sides of the upper body.

FIG. 4A is a view taken along section line 4A-4A in FIGS. 2A and 3A showing phantom lines of the superimposed, dual drain-grooves in the upper body near the back side viewed from the front side of the upper body with the drain-grooves sloping downwardly in both directions from the point near the top surface counterclockwise to the corner point on the left and sloping downwardly from point clockwise to the corner point on the right.

FIG. 4B is an elevational view from the right side of the upper body taken along section line 4B-4B in FIGS. 2A and 3A showing counterclockwise phantom lines of the drain-grooves sloping downwardly along the left side from point D2 via point D3 to point D4 where it is even deeper than at point D2 below the top surface which is shown on the left. The underside is shown on the right.

FIG. 4C is an elevational view taken from the left side of the upper body 11 taken along section line 4C-4C in FIGS. 2A and 3A showing clockwise phantom lines of the drain-grooves sloping downwardly along the right side from point D2 via point D3 to point D4 which reaches a depth equally deeper than at point D2 below the top surface which is shown on the right, to the depth shown in FIG. 4B. The underside is shown on the left.

FIG. 4D is a an elevational view from the front side of the upper body showing counterclockwise and clockwise phantom lines of the drain-grooves converging from points D4 on the left and right respectively to points D5 at the open sides of the drain hole where are the phantom lines slope to their deepest level below point D4.

FIG. 5A is an inverted, elevational, front view of the FIG. 2A cutting board of showing the underside of the upper body of the cutting board including the left leg and right legs and the peripheral drain hole.

FIG. 5B is an inverted, elevational, front view of the FIG. 3C cutting board with the left and right legs assembled to the planar underside of the upper body.

FIG. 5C is an inverted, elevational, front view of the FIG. 5B cutting board with the drain pan inserted into the open space above the underside of the upper body and between the legs of the cutting board.

FIG. 6A is an elevational front view of the left leg showing the front wall 17F of the cutting board of FIG. 2C.

FIG. 6B is an elevational inside view of the left leg of FIG. 6A showing the vertical inside wall and the shallow, narrow, horizontal recess which extends far enough along the inside wall to house the drain pan rim when the drain pan is inserted into the cutting board.

FIG. 6C is a top view of the left leg of FIG. 6A showing the horizontal top surface and the horizontal surface of the narrow, horizontal recess.

FIG. 6D is an elevational outside view of the left leg of FIG. 6A showing the vertical outside wall with a recessed handle formed therein. The front wall, underside, and the back wall are identified in the drawing.

FIG. 7A is an elevational view of the right leg showing the front wall of the cutting board of FIG. 2C.

FIG. 7B is an elevational inside view of the left leg of FIG. 7A showing the vertical inside wall and the shallow, narrow, horizontal recess which extends far enough along the inside wall to house the drain pan rim when the drain pan is inserted into the cutting board.

FIG. 7C is a top view of the left leg of FIG. 7A showing the horizontal top surface and the horizontal surface of the shallow, narrow, horizontal recess.

FIG. 7D is an elevational outside view of the left leg of FIG. 7A showing the vertical outside wall, the recessed handle 18H formed therein, the front wall, the underside, and the back wall.

FIG. 8A is an elevational front view of the cutting board with both the top surface of the left leg and the top planar surface of the right leg joined with the planar, underside of the upper body.

FIG. 8B is an elevational left side view of cutting board showing the left side of the cutting board with the planar, underside of upper body joined to the planar, top surface of the left leg.

FIG. 8C is an elevational right side view of the cutting board showing the right side view of cutting board with the planar, underside of the upper body joined to the planar, top surface of the right leg

FIGS. 9A-9C shows the front elevation of the drain pan shown in FIG. 2D, installed in the cutting board with the top surfaces of the left and right legs joined with the planar underside of the upper body to form the drain pan rim housing slots.

FIG. 9B shows a front elevation of the drain pan with the drain pan rim and the drain pan hollow.

FIG. 9C shows a top view of the drain pan with the drain pan rim surrounding the drain pan hollow.

FIG. 10 shows a front elevation of the cutting board with the drain pan installed, as shown in both FIGS. 2D/9A with two support feet shown attached to the legs.

FIG. 11 is a flow chart of the steps of manufacture and assembly of the cutting board with the concentric, dual, drain-grooves, and installation of the drain pan below the upper body between the cutting board legs.

### DETAILED DESCRIPTION OF THE INVENTION

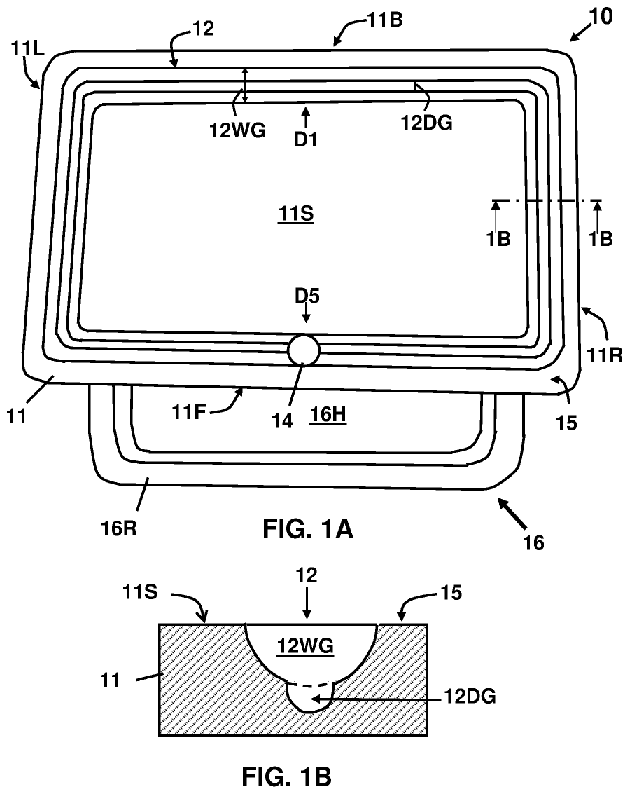

FIG. 1A is a perspective view of a cutting board 10 in accordance with this invention for cutting of meats, fruits, or vegetables and collecting juices therefrom into a drain pan 16. The cutting board 10 has an upper body 11 with a sloped dual-groove drain ring 12, and a drain hole 14 through the upper body 11.

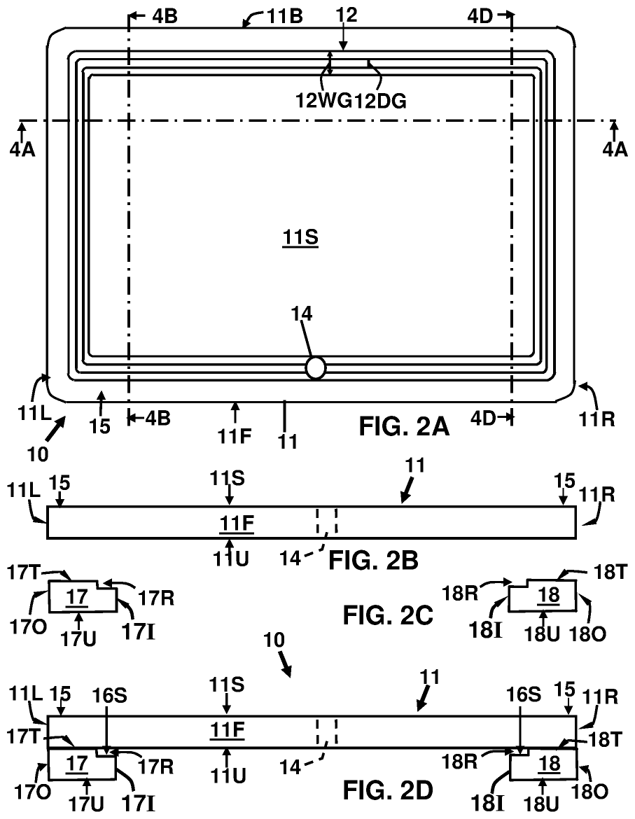

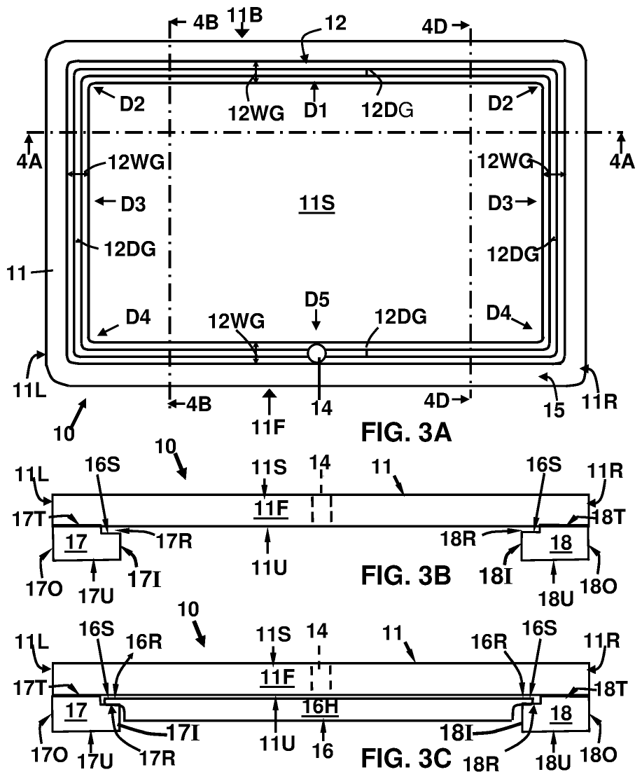

The sloped, dual-groove, drain ring 12, formed in the planar top surface 11S, which extends parallel to the periphery of cutting board 10, leads to the drain hole 14 for draining juices into a drain pan hollow 16H of a drain pan 16 temporarily installed in the cutting board 10. below the upper body 11. The drain pan 16 with its hollow 16H is provided to collect juices from the drain hole 14. The drain pan 16 has a drain pan rim 16R that surrounds the drain pan hollow 16H. The left and right sides of drain pan rim 16R are adapted to slide into and out of tracks formed by drain pan rim housing slots 16S (shown in FIG. 2D) between underside 11U of the upper body 11 and the legs 17/18 (as shown in FIG. 3C) of the cutting board 10.

The sloped peripheral, dual-groove, drain ring 12 comprises coaxial superimposed, drain-grooves 12DG/12WG formed, with a common centerline in the top surface 11S. The drain-grooves 12DG/12WG extend parallel to the periphery of the upper body 11 spaced therefrom by a narrow border 15 on the top surface 11S. The shallowest depth of the dual-groove, drain ring 12 begins at a point D1 on the backside 1B that slopes in both clockwise and counter-clockwise directions, down to a drain hole 14 at point D5 on the front side 11F.

FIG. 1B is a fragmentary sectional view showing the cross section of the peripheral drain ring 12 taken along section line 1B-1B in FIG. 1A. Drain ring 12 comprises a shallow wide groove 12WG formed in the top surface 11S of the upper body 11 inside the narrow border 15 of the top surface 11S. The narrow deep groove 12DG is nested and superimposed, deep inside the bottom of the shallow the wide groove 12WG and concentric therewith. In other words, the dual-grooves comprise a narrow deep groove 12DG nested deep inside the bottom of a shallow wide groove 12WG formed in the top surface 11S.

Referring again to FIG. 1A, the drain ring 12 gradually slopes, deeper into the top surface 11S, towards the underside 11U of the upper body 11 from point D1 to point D5. The drain ring 12 becomes increasingly deeper, from the shallowest depth at point D1 to the greatest depth at point D5 of the drain ring 12 in the planar top surface 11S in both the clockwise and counterclockwise directions. Thus the juices flow, in both directions, deeper towards the drain hole 14 located at point D5 on the front 11F. The slope facilitates rapid drainage of juices from the planar top surface 11S of the upper body 11 of the cutting board 10 towards the drain hole 14.

The drain ring 12 comprises the superimposed, nested, concentric grooves including a narrow deep groove 12DG, that as shown in FIG. 1B, is centered down in the bottom of a wide shallow groove 12WG. Debris formed by cutting food collects in shallow wide groove 12WG which obstructs rapid flow of juices. However the obstruction of flow in the wide groove 12WG is bypassed by the unobstructed deeper groove 12DG which delivers juices rapidly to the drain pan hollow 16H.

The drain ring 12, formed in the top surface 11S of the upper body 11, gradually slopes downwardly deeper, both clockwise and counterclockwise, from the shallower depth at point D1 to the greater depth at point D6 of the drain ring 12 in the planar top surface 11S to drain juices towards the drain hole 14 located at point D5. The peripheral drain ring 12, slopes downwardly deeper in both clockwise and counterclockwise directions, from the shallower depth at point D1 to a greater depth at point D6 of the drain ring 12 in the planar top surface 11S to drain juices towards the drain hole 14 located at point D6. The drain ring 12 comprises nested, concentric grooves including a narrow deep groove 12DG that is centered down in the bottom of a wide shallow groove 12WG

FIG. 1B is a fragmentary sectional view showing the cross section of the peripheral drain ring 12 taken along section line 1B-1B in FIG. 1A. Drain ring 12 comprises a shallow wide groove 12WG formed in the top surface 11S of the upper body 11 located inside the narrow border 15 of the top surface 11S. The narrow deep groove 12DG is nested deep inside the bottom of the shallow wide groove 12WG.

FIG. 2A is a plan view of the top surface 11S of the of the cutting board 10 of FIG. 1A showing the peripheral drain ring 12 and the narrow deep groove 12DG centered inside the wide shallow groove 12WG, as described above. The top surface 11S, the front side 11F, the left side 11L, the right side 11R, and the backside 1B are identified.

FIG. 2B is an elevational view of the front 11F of the upper body 11 of the cutting board 10 of FIGS. 1A and 2A. The top surface 11S of the upper body 11 is preferably a planar as is the underside 11U of the upper body 11. The grooves 12DG/12WG, the front side 11F, the left side 11L, and the right side 11R are identified.

FIG. 2C is an elevational, front views of both left leg 17 and right leg 18 of cutting board 10. The left leg 17, which is generally rectangular, has a vertical outside wall 17O, a vertical inside wall 17I, a horizontal top surface 17T and a horizontal underside surface 17U. A narrow, horizontal drain pan rim recess 17R is formed at the corner of the left leg 17 comprising the intersection of the horizontal top surface 17T and the vertical inside wall 17I.

Similarly, the right leg 18, which is also generally rectangular, has a vertical outside wall 18O, a vertical inside wall 18I, a horizontal top surface 18T and a horizontal underside surface 18U. A narrow, horizontal drain pan rim recess 18R is formed at the corner of the right leg 18, comprising the intersection of the horizontal top surface 18T and the vertical inside wall 18I.

In other words, the upper right, inside corner of left leg 17 has the narrow horizontal recess 17R, comprising the intersection of the top surface 17T and the inside wall 17I of left leg 17. The narrow horizontal recess 17R is adapted to support the left side of the drain pan rim 16R. The upper left, inner corner of right leg 18 has a matching narrow horizontal recess 18R at the intersection of the horizontal top surface 18T and the vertical inside wall 18I of right leg 18 meet. The horizontal recess 18R is adapted to support the right side of the drain pan rim 16R.

FIG. 2D is an elevational front view of the cutting board 10 with the top surfaces 17T and 18T of the left leg 17 and right leg 18 respectively joined with the planar underside 11U of the upper body 11 forming the drain pan rim housing slots 16S therebetween. The tracks for the drain pan rim 16R comprise housing slots 16R. The housing slots 16R comprise the narrow spaces between each of the recesses 17R and 18R on the left and right, and the underside 11U of the upper body 11. The housing slots 16S on both the left and right sides of the cutting board 10 provide tracks which hold and support the drain pan rims 16R of the drain pan 16. The drain pan 16 is insertable and removable from the cutting board 10 by sliding the lateral sides of the drain pan rim 16R which can ride in the tracks formed by housing slots 16S on both the left and right sides on planar top surfaces 17T/18T of the recesses 17R and 18R and rest there temporarily, when inserted. In summary, the housing slots 16S are located between the narrow, top, horizontal, surfaces of the recesses 17R and 18R of the left leg 17 and right leg 18 from the cutting board 10 and the underside 11U of the upper body 11U. Thus, the left leg 17 and right leg 18 removably support the drain pan 16 in the space below upper body 11 between the left leg 17 and the right leg 18. While so inserted, the drain pan 16 is temporarily secured to the cutting board 10, as an integral part of the cutting board 10. In this view it is clearer how the drain pan rim insertion slots 16S can removably house and support the drain pan 16 when both sides of the drain pan rim 16R are inserted into the corresponding tracks formed by the housing slots 16S for drain pan rim 16R. Thus, the drain pan 16 is housed by the cutting board 10 between left leg 17 and right leg 18 below the upper body 11. The drain pan 16 can be inserted and removed from the cutting board 10 before and after collecting juices from the cutting board 10.

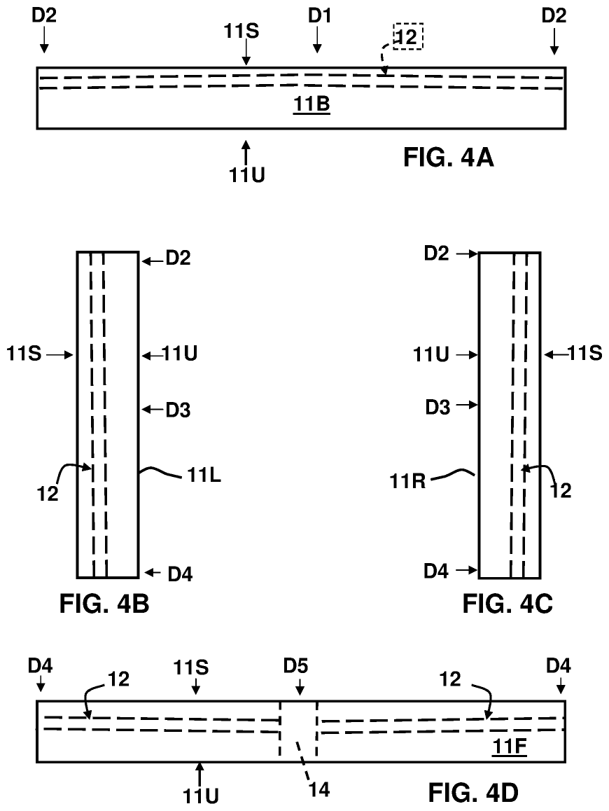

The left leg 16 and the right leg 17 are rigidly secured to the upper body 11 of the cutting board 10 by fasteners with no phantom lines shown for convenience of illustration, as will be understood by those skilled in the art. The phantom lines of the drain-grooves 12DG/12WG shown in FIGS. 4A-4D are not shown in both of FIG. 2B and FIG. 2D to focus the drawings on the recesses 17R and 18R in top surfaces and inner sides of the left leg 17 and the right leg 18 for the drain pan 16, as will be well understood by those skilled in the art.

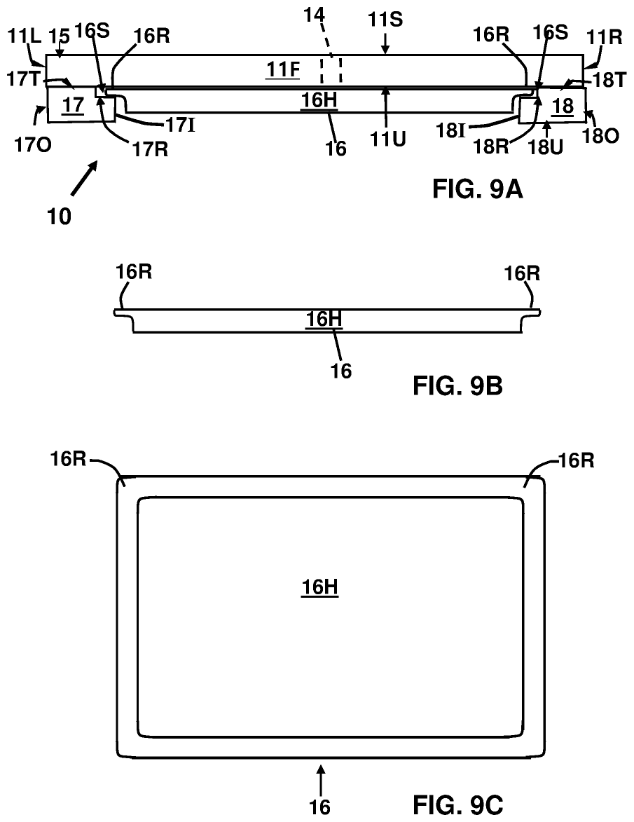

The upper body 11 is supported by both the left leg 17 on the left side 11L and the right leg 18 on the right side 11R, as shown in FIG. 2D. The top surfaces 17T and 18T inside of the legs 17 and 18 have the recesses 17R and 18R shown by FIGS. 2C and 2D. The drain pan 16, which is shown located below the upper body 11, has a drain hollow 16H for collecting in the juices and a drain pan rim 16R that surrounds the hollow 16H. The drain pan 16 is adapted to be supported by the drain pan rim 16R which rest in the tracks formed by slots 16S on the upper surfaces of recesses 17R and 18R as shown by FIGS. 3C and 9A-9C.

Referring again to FIG. 1A, the upper body 11 of the cutting board 10 has a planar top surface 11S with the peripheral dual-groove, drain ring 12 formed therein. The dual-groove, drain ring 12, located on the periphery of the planar top surface 11S, is sloped deeper in the top surface 11S from a shallow depth starting at point D1 on the back side 1B down to the greatest depth at point D5 on the front 11F to facilitate rapid drainage of juices along the planar top surface 11S of the upper body 11 of the cutting board 10.

The drain ring 12 has two branches running from point D1 to point D5. The dual-groove, drain ring 12 extends along the narrow border 15 along the periphery of the to the greatest depth at surface 11S in both directions clockwise and counterclockwise sloping from the shallow depth at point D1 on the back 11B of the cutting board 10 to the greatest depth at point D5 where a drain hole 14 through the upper body 11 is located on the front side 11F of the cutting board 10.

Unlike known drain-groove cutting boards, the peripheral dual-groove, drain ring 12 in accordance with this invention comprises a pair of dual, sloped, superimposed grooves including a narrow deep, groove 12DG that is centered within a shallow wide, groove 12WG formed extending along the planar top surface 11S of the upper body 11.

The depths of the narrow, deep groove 12DG and the shallow wide, groove 12WG of the drain ring 12 both increase, sloping from point D1 on the back of the cutting board 10 to a point D5 where a drain hole 14 is located on the front of the cutting board 10.

The depths of the groove 12DG and groove 12WG in drain ring 12 are shallowest at point D1 and slope downwardly in both directions to their deepest at point D5 on the front of the cutting board 10 where the drain hole 14 is located. A narrow border 15 of planar top surface 11S surrounds the dual-grooves 12WG and 12DG.

The drain hole 14 is an unobstructed opening extending through the upper body 11 of the cutting board 10. Drain hole 14 is open and permits juices to drain therethrough down into the drain hollow 16H of the drain pan 16, when it is installed below the upper body 11S in the space between the left leg 17 and right leg 18 of cutting board 10. As explained above, the drain pan 16 slides in and out of the front side 11F of cutting board 10.

Thus space between the upper body 11 and the lateral recesses 17R and 18 R in the left leg 17 and the right leg 18 make it possible for the drain pan rim 16R that is adapted to support the drain pan 16 to be inserted and removed from the drain pan space beneath the upper body 11 of the cutting board 10 before and after collecting juices from the cutting board 10. The left leg 16 and the right leg 17 are rigidly secured to the upper body 11 of the cutting board 10 by fasteners with no phantom lines shown for convenience of illustration, as will be understood by those skilled in the art. The phantom lines of the drain-grooves 12DG/12WG in drain ring 12 shown in FIGS. 4A-4D are not shown in both of FIG. 2B and FIG. 2D to focus the drawings on the recesses 17R and 18R in top surfaces and inner sides of the left leg 17 and the right leg 18 for the drain pan 16, as will be well understood by those skilled in the art.

FIG. 3A is a modified plan view of the top surface 11S of the upper body 11 of the cutting board 10 of FIGS. 1A and 2A. FIG. 3A shows the peripheral drain ring 12 with the narrow deep groove 12DG nested in the center of wide shallow groove 12WG. Those drain-grooves 12DG/12WG in drain ring 12 facilitate drainage of juices from the planar top surface 11S of the upper body 11 of the cutting board 10. The peripheral drain ring 12 facilitates drainage of juices along the planar top surface 11S of the upper body 11 of the cutting board 10 starting at point D1 on the backside 1B sloping down to a drain hole 14 at point D5 on the front side 11F. Between those points, from point D1 the shallow starting point of the drain-grooves 12DG/12WG, the juices flow in opposite directions to both corner points D2 on the left and right corners of the backside of the upper body 11. Next the flow passes by points D3 in the middle of the left and right sides of the top surface 11S. Then the flow proceeds to the corner points D4 at the left and right corners at the on the top of top surface 11S. The grooves in the drain ring 12 are deepest at point D5 where they reach the drain hole 14 at point D5 in the middle of the front 11F between the left and right corner points D4

FIG. 3B is an elevational, front view of the cutting board 10 of FIG. 3A (as shown by FIG. 2D) with the left leg 17 and right leg 18 assembled with the underside 11U of the planar, upper body 11. There is an open space below the upper body 11 and between the legs 17/18 of the cutting board 10 and there are the empty slots below the underside 11U the upper body 11 an on top of the recesses 17R/18R.

FIG. 3C is an elevational, front view of the cutting board 10 the drain pan 16 inserted into the open space below the upper body 11 and between the legs 17/18 of the cutting board 10. The drain pan 16 and the lateral sides of the drain pan rim 16R are inserted into the slots 16S in the cutting board 10. The rims 16R of the drain pan 16 rest within slots 16S on top of the recesses 17R/18R in the inner, upper corners of the surfaces of legs 17/18. The drain hole 14 shown in phantom is open to permit juices to flow into the drain pan hollow 16H of drain pan 16. Yet the drain pan 16 is readily, insertable into and removed from the front side 11F of the cutting board 10 by sliding it in and out of the slots 16S on the left and right between the underside 11U and the indented the upper surfaces of recesses 17R/18R in the legs 17 and 18.

FIGS. 4A-4D are four elevational views showing phantom lines of the drain-grooves 12DG/12WG in the upper body 11 viewed from sides of the upper body 11.

FIG. 4A is a view taken along section line 4A-4A in FIGS. 2A and 3A showing phantom lines of the drain-grooves 12DG/12WG in the upper body 11 near the back side 1B viewed from the front side 11F of the upper body 11 with the drain-grooves 12DG/12WG sloping downwardly in both directions from the point D1 near the top surface 11S counterclockwise to the corner point D2 on the left and sloping downwardly from point D1 clockwise to the corner point D2 on the right.

FIG. 4B is an elevational view from the right side of the upper body 11 taken along section line 4B-4B in FIGS. 2A and 3A showing counterclockwise phantom lines of the drain-grooves 12DG/12WG sloping downwardly along the left side 11L from point D2 via point D3 to point D4 where it is even deeper than at point D2 below the top surface 11S which is shown on the left. The underside 11U shown on the right.

FIG. 4C is an elevational view taken from the left side of the upper body 11 taken along section line 4C-4C in FIGS. 2A and 3A showing clockwise phantom lines of the drain-grooves 12DG/12WG sloping downwardly along the right side 11R from point D2 via point D3 to point D4 which reaches a depth equally deeper than at point D2 below the top surface 11S which is shown on the right, to the depth shown in FIG. 4B. The underside 11U is shown on the left.

FIG. 4D is a an elevational view from the front side of the upper body 11 showing counterclockwise and clockwise phantom lines of the drain-grooves 12DG/12WG converging from points D4 on the left and right respectively to points D5 at the open sides of the drain hole 14 where are the phantom lines slope to their deepest level below point D4.

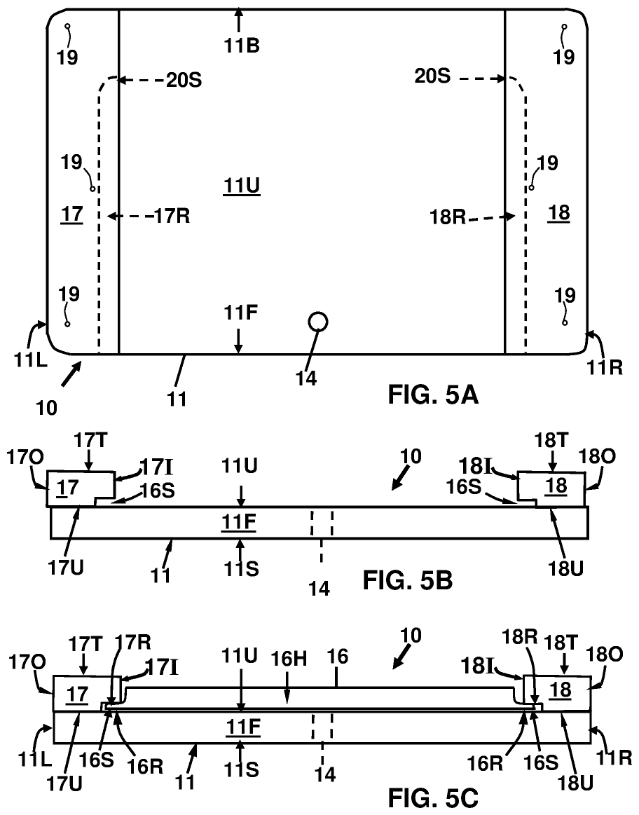

FIG. 5A is an inverted, elevational, front view of the cutting board 10 of FIG. 2A showing the underside 11U of the upper body 11 of the cutting board 10 including the left leg 17, right leg 18 and the peripheral drain hole 14 with the left leg recess 17R and right leg 18R recess shown in phantom. The drain pan 16 is omitted to show the drain hole 14.

The upper board 11 may be fabricated separate from the legs 17/18 which are joined to the upper board 11 with screws in screw holes 19. The screws in holes 19 extend through the legs 17/18 extending from the undersides 17U/18U of the legs 17/18 and only partially into pilot holes in the upper board 11 to fasten the legs 17/18 to the upper body 11.

The preferred screws are 316 SST S/M/S Phillips pan head screws, i.e. stainless steel sheet metal screws. The left leg recess 17R and right leg 18R recess have track stop points 20S in slots 16S to prevent the drain pan rim 16R from sliding too far into the slots 16S below the underside 11U. Thus, the pan 16 will be in position to collect juices and will not extend out of the back of cutting board 10.

FIG. 5B is an inverted, elevational, front view of the cutting board 10 of FIG. 3C with the left leg 17 and right leg 18 assembled to the planar underside 11U of the upper body 11.

FIG. 5C is an inverted, elevational, front view of the cutting board 10 of FIG. 5B with the drain pan 16 inserted into the open space above the underside 11U of the upper body 11 and between the vertical inside walls 17I/18I walls of the legs 17/18 of the cutting board 10.

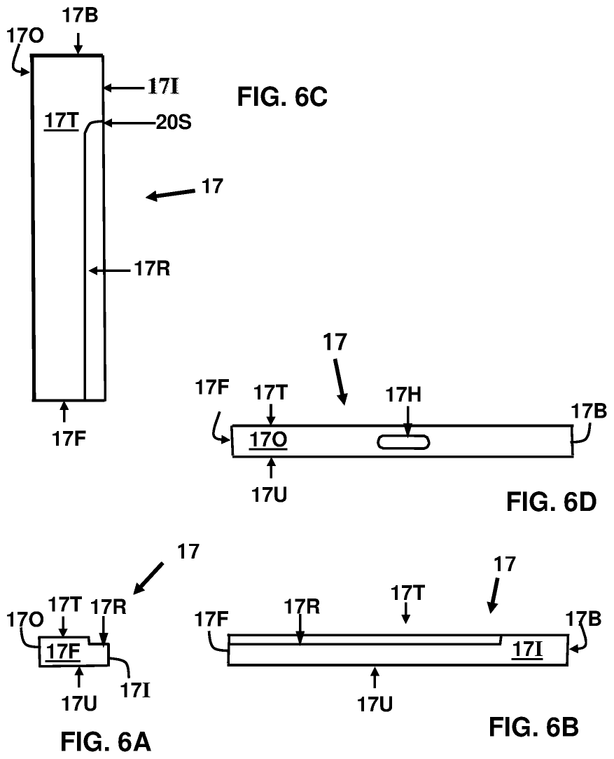

FIG. 6A is an elevational front view of the left leg 17 showing the front wall 17F of the cutting board 10 of FIG. 2C. The left leg 17, which is generally rectangular, also has a vertical outside wall 17O, a vertical inside wall 17I, a horizontal top surface 17T and the horizontal underside surface 17U.

The shallow, narrow, horizontal recess 17R is formed at the corner at the intersection of the horizontal top surface 17T and the vertical inside wall 17I. The left leg recess 17R and right leg 18R recess have track stop points 20S in slots 16S to prevent the drain pan rim 16 from sliding too far into the slots 16S below the underside 11U. Thus, the pan 16 will be in position to collect juices and will not extend out of the back of cutting board 10.

FIG. 6B is an elevational inside view of the left leg 17 of FIG. 6A showing the vertical inside wall 17I and the shallow, narrow, horizontal recess 17R which extends far enough along the inside wall 17I to house the drain pan rim 16R when the drain pan 16 is inserted into the cutting board 10. The back wall 17B is identified in the drawing.

FIG. 6C is a top view of the left leg 17 of FIG. 6A showing the horizontal top surface 17T and the planar surface of the narrow, horizontal recess 17R. The front wall 17F, inside wall 17I, the back wall 17B and the outside wall 17O are identified in the drawing.

FIG. 6D is an elevational outside view of the left leg 17 of FIG. 6A showing the vertical outside wall 17O with a recessed handle 17H formed therein. The front wall 17F, underside 17U, and the back wall 17B are identified in the drawing.

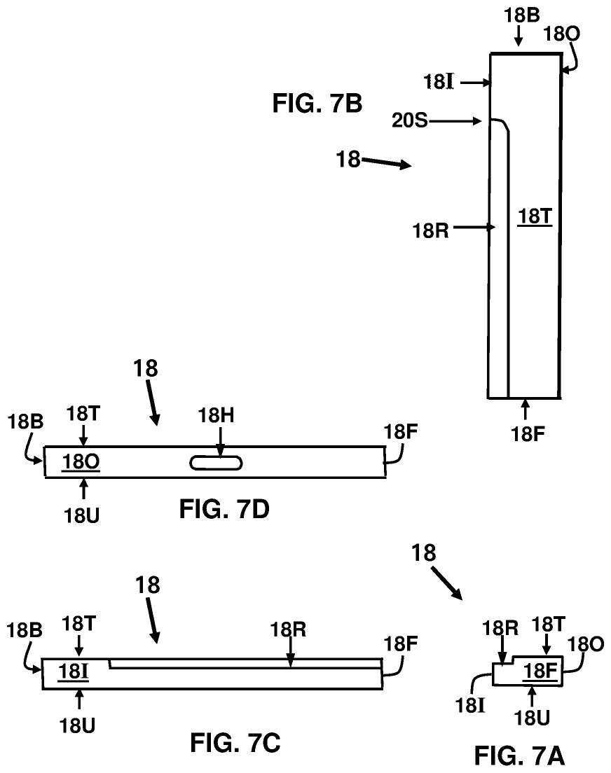

FIG. 7A is an elevational view of the right leg 18 showing the front wall 18F of the cutting board 10 of FIG. 2C. The generally rectangular right leg 18 has a vertical outside wall 18O, a vertical inside wall 18I, a horizontal top surface 18T and the horizontal underside surface 18U. The narrow, horizontal recess 18R is formed at the corner comprising the intersection of the horizontal top surface 18T and the vertical inside wall 18I.

FIG. 7B is an elevational inside view of the left leg 18 of FIG. 7A showing the vertical inside wall 18I and the shallow, narrow, horizontal recess 18R which extends far enough along the inside wall 18I to house the drain pan rim 16R when the drain pan 16 is inserted into the cutting board 10. The back wall 18B is identified in the drawing.

FIG. 7C is a top view of the left leg 18 of FIG. 7A showing the horizontal top surface 18T and the horizontal surface of the shallow, narrow, horizontal recess 18R. The back wall 18B is identified in the drawing.

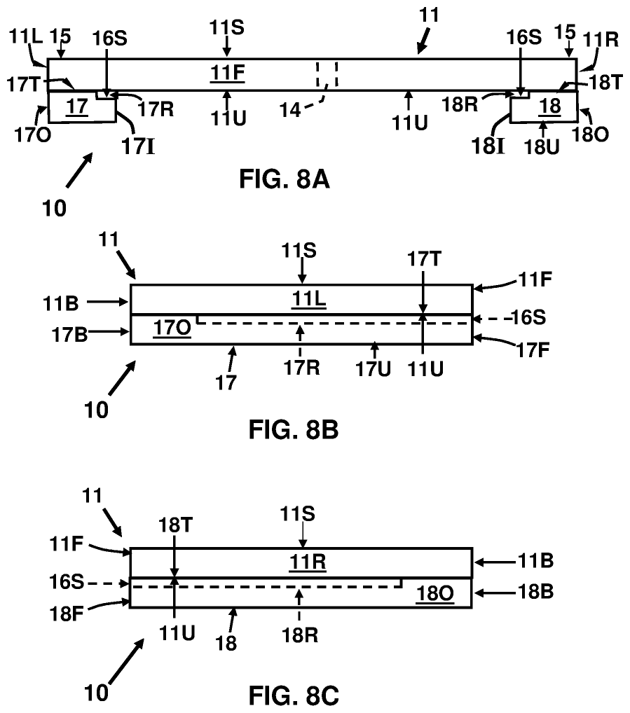

FIG. 8A is an elevational front view of the cutting board 10 with both the top surface 17T of the left leg 17 and the top surface 18T of the right leg 18 joined with the planar, underside 11U of the upper body 11. The drain pan 16 is omitted from this view for convenience of illustration. Other various features shown are described above with reference to FIG. 2D.

FIG. 8B is an elevational left side view of cutting board 10 showing the left side 11L of upper body 11 located above the outside wall 17O of the left leg 17. The planar, underside 11U of the upper body 11 is joined to the planar, top surface 17T of the left leg 17.

FIG. 8C is an elevational right side view of cutting board 10 showing the right side view of cutting board 10 showing the left side 11R of upper body 11 located above the outside wall 18O of the right leg 18. The planar, underside 11U of the upper body 11 is joined to the planar, top surface 18T of the right leg 18,

FIG. 9A shows the front elevation of the is an elevational front view of the cutting board 10 with drain pan 16 installed as shown in FIG. 2D, installed in the cutting board 11 with the planar top surfaces of the left and right legs 17/18 joined with the planar underside of the upper body 11 to form the drain pan rim housing slots 16S. The other various features shown and described above with reference to FIG. 2D.

FIG. 9B shows a front elevation of the drain pan 16 with the drain pan rim 16R and the drain pan hollow 16H.

FIG. 9C shows a top view of the drain pan 16 with the drain pan rim 16R surrounding the drain pan hollow 16H.

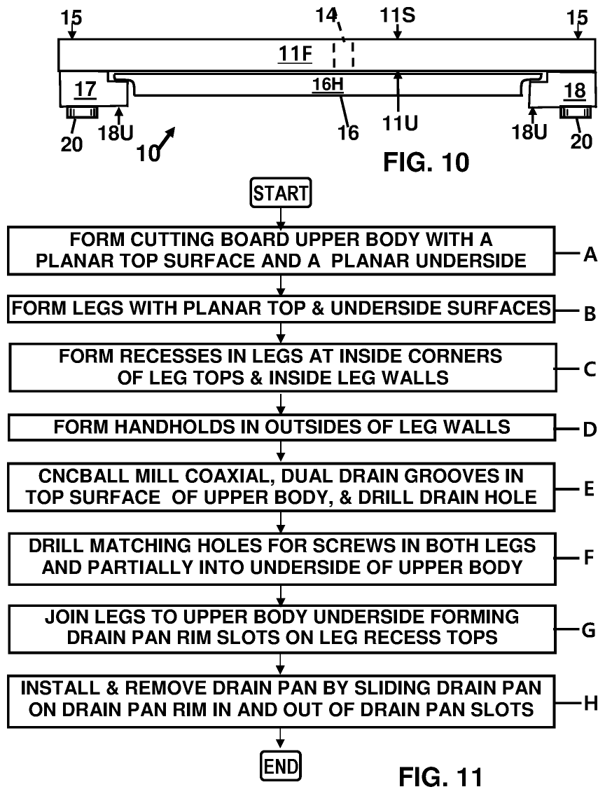

FIG. 10 shows the front elevation of the cutting board 10 with the drain pan 16 installed, as shown in both FIGS. 2D and 9A with two of the four support feet 20 shown attached to the legs 17/18. The other features shown are described above with reference to FIG. 2D.

FIG. 11 is a flow chart of the steps of manufacture and assembly of the cutting board 10 with concentric, dual, drain-grooves 11WG/12NG and installation of drain pan 16 below the upper body 11 between the legs 17/18. Steps A to H may be performed in a different sequence than shown. The purpose is to identify the main steps that need to be taken to produce the cutting board 10 with concentric, drain grooves 11WG/12NG and easily installation and removal of drain pan 16 below the upper body 11 between the legs 17/18.

The method steps in FIG. 11 begin at START

In step A, fabricate the cutting board upper body 11 with a planar top surface 11S and a planar underside 11U.

In step B, fabricate the left and right legs 17/18 with planar tops 17T/18T and underside surfaces 17U/18U.

In step C, form recesses 17R/18R at inside corners of inside leg walls 17I/18I on leg tops 17T/18T to form the space for drain pan housing slots 16S.

In step D, form hand holds 20 in outside leg walls 17O/18O.

In step E, with CNC, ball mill the nested concentric dual drain grooves 12DG/12WG in the top surface 11S of upper body 11, and drill a drain hole 14 through the upper body 11.

In step F, drill matching holes 19 for screws in both legs 17/18 extending only partially into the underside 11U of upper body 11.

In step G, join both legs 17/18 to the underside 11U of the upper body 11 with screws through the feet 20 and form the two drain pan rim slots 16S between underside 11U of upper body 11 and the top surfaces of recesses 17R/18R in both legs 17/18.

In step H, install drain pan 16 in cutting board 10 by sliding drain pan rim 16R into drain pan housing slots 16S on the left & right sides;

The steps of the method are completed at END

The preferred cutting board material is High-Density PolyEthylene (HDPE) also known as PolyEthylene High-density (PEHD) that is acceptable for food products. The upper board 11 is fabricated separate from the legs 17/18 which are joined to the upper board 11 with screws. The screw holes 19 extend up from the undersides 17U/18U of the legs 17/18 and partially through the upper board 11. The preferred screws are 316 SST S/M/S Phillips pan head screws, i.e. stainless steel sheet metal screws.

TABLE 1

| | Shallow | Shallow | Deep | Deep |
|---|---|---|---|---|
| | Groove | Groove | Groove | Groove |
| POINT | Width | Depth | Width | Depth |
| D1 | 0.750″ | 0.1250″ | 0.250 | 0.1750″ |
| D2 | 0.750″ | 0.2004″ | 0.250 | 0.3004″ |
| D3 | 0.750″ | 0.2500″ | 0.250 | 0.3500″ |
| D4 | 0.750″ | 0.3000″ | 0.250 | 0.4000″ |
| D5 | 0.750″ | 0.3750″ | 0.250 | 0.5250″ |

The foregoing description discloses exemplary embodiments of the invention. Modifications of apparatus and methods disclosed above within the scope of the invention will be readily apparent to those of ordinary skill in the art.

While this invention is described in terms of the above embodiment(s), those skilled in the art will recognize that the invention can be practiced with modifications within the spirit and scope of the appended claims, i.e. changes can be made in form and detail, without departing from the spirit and scope of the invention.

Accordingly, while the present invention is disclosed in connection with exemplary embodiments thereof, it should be understood that changes can be made to provide other embodiments which may fall within the spirit and scope of the invention and all such changes come within the purview of the present invention and the invention encompasses the subject matter defined by the following claims.

What is claimed is:

1. A cutting board and an upper body both have a front side, a back side, a left side, and a right side, with the upper body also having a top surface, a periphery and an underside below the top surface as well as the front side, the middle, the back side, the left side, and the right side,
a drain hole extending through the upper body from the top surface to the underside of the upper body,
dual, concentric nested, drain-grooves formed in the top surface extending from a first end to an outlet end with the nested, drain-grooves comprising a first groove and a superimposed, second drain-groove formed inside the first groove, the first groove being shallow and wide, the superimposed, second drain-groove being deeper and narrower than the first groove, and
the outlet end of the drain-grooves being connected to the drain hole.

2. The cutting board of claim 1 wherein the drain-grooves slope deeper, from a high point on the top surface to a low point at the outlet end.

3. The cutting board of claim 1 wherein the drain-grooves extend proximate to the periphery and slope deeper, from a high point near the middle of the back side of the top surface to a low point at the drain hole near the middle of the front side.

4. The cutting board of claim 1 wherein the drain-grooves extend near the periphery from a starting point at a shallowest level near the middle of the back side of the upper body and slope to a deepest level to the at the outlet end and the drain hole near the front side.

5. The cutting board of claim 4 wherein the grooves extend both clockwise and counterclockwise from a starting point near the middle of the back side along the periphery to join at the outlet end and the drain hole near the front side.

6. The cutting board of claim 1 wherein upper body is supported by and left and right legs secured to the underside of the left and right sides of the upper body of the cutting board.

7. The cutting board of claim 6 wherein the left and right legs have recesses forming left and right drain pan rim slots between the recesses and the underside off the upper body.

8. The cutting board of claim 7 wherein a drain pan with a drain pan rim and a drain pan hollow is removably housed in a space below the underside of the upper body and supported by the left and right drain pan rim legs slots above the recesses.

9. The cutting board of claim 8 wherein the drain pan is slidably supported by the drain pan rim inserted into slots forming tracks between the underside of the upper body and on the top surfaces of the recesses in of the left and right legs.

10. The cutting board of claim 9 wherein feet are fastened to undersides of the legs and stop points are formed at the ends of the slots.

11. A method of forming a cutting board and an upper body both having a front side, a back side, a left side, and a right side, with the upper body also having a top surface, a periphery and an underside below the top surface as well as the front side, the middle, the back side, the left side, and the right side,
forming a drain hole extending through the upper body from the top surface to the underside of the upper body
forming dual, concentric nested, drain-grooves in the top surface extending from a first end to an outlet end, with the nested, drain-grooves comprising a first groove and a superimposed, second drain-groove formed inside the first groove, the first groove being shallow and wide, and the superimposed, second drain-groove being deeper and narrower than the first groove, and
connecting the outlet end of the drain-grooves to the drain hole.

12. The method of claim 11 wherein the drain-grooves slope deeper, from a high point on the top surface to a low point at the outlet end.

13. The method of claim 1 wherein the drain-grooves extend proximate to the periphery and slope deeper, from a high point near the middle of the back side of the top surface to a low point at the drain hole near the middle of the front side.

14. The method of claim 11 wherein the drain-grooves extend near the periphery from a starting point at a shallowest level near the middle of the back side of the upper body and slope to a deepest level to the at the outlet end and the drain hole near the front side.

15. The method of claim 14 wherein the grooves extend both clockwise and counterclockwise from a starting point near the middle of the back side along the periphery to join at the outlet end and the drain hole near the front side.

16. The method of claim 11 wherein upper body is supported by and left and right legs secured to the underside of the left and right sides of the upper body of the cutting board.

17. The method of claim 16 wherein the left and right legs have recesses forming tracks in the left and right drain pan rim slots between the recesses and the underside off the upper body.

18. The method of claim 17 wherein a drain pan with a drain pan rim and a drain pan hollow is removably housed in a space below the underside of the upper body and supported by tracks formed by the left and right drain pan rim legs slots above the recesses.

19. The method of claim 18 wherein the drain pan is slidably supported by the drain pan rim inserted in the tracks between the underside of the upper body and on the top surfaces top of the recesses in of the left and right legs.

20. The method of claim 19 wherein feet are fastened to undersides of the legs with stop points formed at the ends of the slots.
